(19) United States
(12) Patent Application Publication
(10) Pub. No.: US 2013/0043800 A1
(43) Pub. Date: Feb. 21, 2013

(54) POWER CONVERTER AND A DIMMABLE SOLID-STATE LIGHTING DEVICE WITH THE POWER CONVERTER

(71) Applicant: WEN-KUEI TSAI, Taipei City (TW)

(72) Inventor: WEN-KUEI TSAI, Taipei City (TW)

(73) Assignee: GE INVESTMENT CO., LTD., Taipei City (TW)

(21) Appl. No.: 13/588,685

(22) Filed: Aug. 17, 2012

(30) Foreign Application Priority Data
Aug. 19, 2011 (TW) 100129675

(51) Int. Cl. G05F 1/46; H05B 37/00

(52) U.S. Cl. 315/201; 323/234

(57) ABSTRACT

The present invention is directed to a power converter, which receives a rectified voltage converted by a rectifier that is coupled to receive an output of a dimmer. The power converter generates a direct-current output voltage according to the rectified voltage in a non-isolated switching boost mode, and the generated direct-current output voltage is provided to at least one solid-state lighting element.

### CROSS-REFERENCE TO RELATED APPLICATIONS

The entire contents of Taiwan Patent Application No. 100129675, filed on Aug. 19, 2011, from which this application claims priority, are incorporated herein by reference.

### BACKGROUND OF THE INVENTION

1. Field of the Invention

The present invention generally relates to a power converter having a direct-current output, and more particularly to a solid-state lighting device using a non-isolated switching boost power converter.

2. Description of Related Art

A dimmer is a control circuit for adjusting the brightness of the lighting device (for example, an incandescent light bulb). FIG. 1A shows a functional block diagram of a dimming system, wherein the dimmer 10 and the light bulb 12 are connected in series, and then the dimmer 10 and the light bulb 12 are respectively connected to two ends of the alternating-current power supply 14. FIG. 1B illustrates a circuit diagram of the dimmer 10 in FIG. 1A, which mainly includes a diac 100 and a triac 102. When the diac 100 reaches a breakover voltage, the conductive current generated by the diac 100 will trigger the triac 102 to be conducted, so as to turn on the light bulb 12. The user may adjust the brightness of the light bulb 12 by a variable resistance (VR).

FIG. 2A shows a functional block diagram of another dimming system, wherein two ends of the alternating-current power supply 14 are connected to two power terminals of the dimmer 10, and two load ends of the dimmer 10 are connected to the light bulb 12. FIG. 2B illustrates a circuit diagram of the dimmer 10 in FIG. 2A, which also mainly includes a diac 100 and a triac 102, as being similar to the dimmer 10 in FIG. 1B.

The dimmer 10 illustrated in FIG. 1A/B or FIG. 2A/B may be adaptable for the conventional lighting device (or the resistive lighting device). However, the solid-state lighting device utilizes a solid-state lighting element (for example, a light emitting diode (LED), an organic light emitting diode (OLED) or a polymer light emitting diode (PLED) to act as a light emitting source, and therefore the solid-state lighting device may need to use a power converter (such as, a switching power converter) to generate a direct-current output power supply for the solid-state lighting element in order to generate a stabilized lightness, compared to the conventional lighting device (for example, an incandescent light bulb or a halogen light bulb).

After a current of the switching power converter mentioned above flows through a bridge rectifier, it may need a capacitor with a large capacitance to generate a waveform output which approaches a direct current. However, the large capacitance may turn the solid-state lighting element into a non-resistive device, which is different from the conventional lighting device (for example, an incandescent light bulb or a halogen light bulb) based on the resistive device. When the switching power converter is directly applied to the solid-state lighting element (or non-resistive lighting device) and the corresponding dimmer 10 is adjusted in a low level, the light is prone to flickering as there is not enough voltage to drive the power converter and the solid-state lighting element. Furthermore, the capacitor with a large capacitance, which is used for providing a stable direct-current voltage, may result in a phase difference between the voltage and the current so that the power factor will be decreased accordingly.

A need has thus arisen to propose a novel scheme of a dimming system, in order to prevent the flickering in the operation and also increase the power factor to achieve the effect of energy saving.

### SUMMARY OF THE INVENTION

In view of the foregoing, an embodiment of the present invention provides a non-isolated switching boost power converter, which not only can increase the power efficiency, but also can provide enough operating voltage level, such that the solid-state lighting element may operate normally. Another objective of the present invention is to decrease the non resistance (or capacitor) effect so as to increase the power factor of the solid-state lighting element and reduce the flickering.

According to one embodiment, a solid-state lighting device includes a rectifier, a non-isolated switching boost power converter and at least one solid-state lighting element. The rectifier receives an output of a dimmer, and then converts the output into a rectified voltage. The power converter receives the rectified voltage to generate an output voltage, which is provided to the solid-state lighting element. In the present invention, the power converter includes a switch controller, an energy storage element, a single switch element and a load capacitor. If the switch controller is in an on state, a control terminal of the switch controller is electrically conducted to a common node, and the rectified voltage charges the energy storage element through the input; and if the switch controller is in an off state, the control terminal of the switch controller is electrically isolated from the common node, and the energy storage element discharges the solid-state lighting element through the single switch element.

### BRIEF DESCRIPTION OF THE DRAWINGS

FIG. 1A shows a functional block diagram of a dimming system.

FIG. 1B illustrates a circuit diagram of the dimmer in FIG. 1A.

FIG. 2A shows a functional block diagram of a dimming system.

FIG. 2B illustrates a circuit diagram of the dimmer in FIG. 2A.

FIG. 3A shows a block diagram of a dimming system according to an embodiment of the present invention.

FIG. 3B shows a block diagram of another dimming system.

FIG. 4 shows a detailed block diagram of a solid-state lighting device according to an embodiment of the present invention.

FIG. 5A shows a detailed circuit diagram of a solid-state lighting device according to an embodiment of the present invention.

FIG. 5B shows signal waveforms of a rectified voltage, an output voltage and a detecting terminal current.

FIG. 5C shows a partial enlarged view of the waveforms of the current Iss at the detecting terminal SS and the voltage Vsw at the control terminal SW.

FIG. 6 shows a detailed circuit diagram of a solid-state lighting device according to another embodiment of the present invention.

FIG. 7A shows a detailed circuit diagram of a solid-state lighting device according to another embodiment of the present invention.

FIG. 7B shows a detailed circuit diagram of a solid-state lighting device according to another embodiment of the present invention.

### DETAILED DESCRIPTION OF THE INVENTION

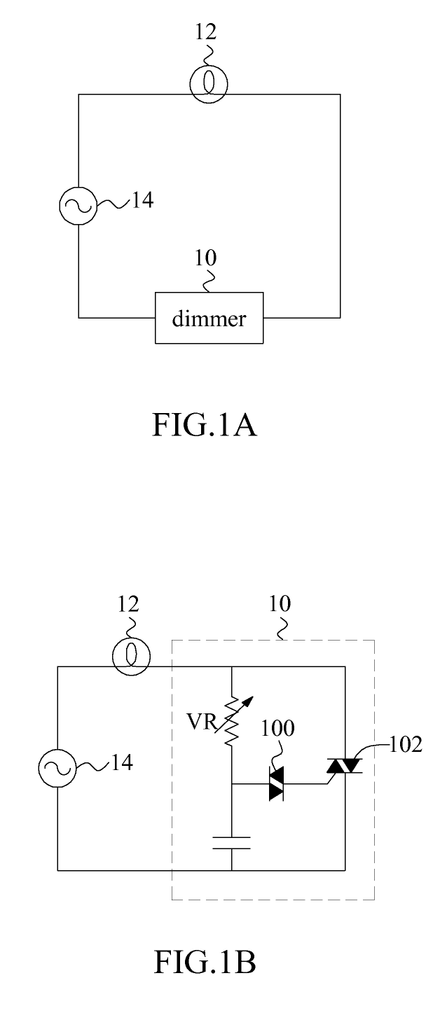

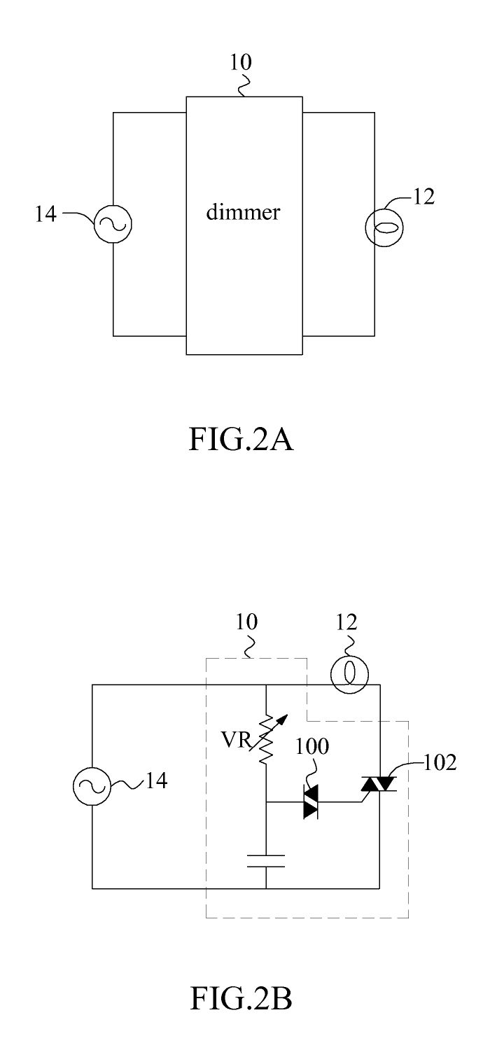

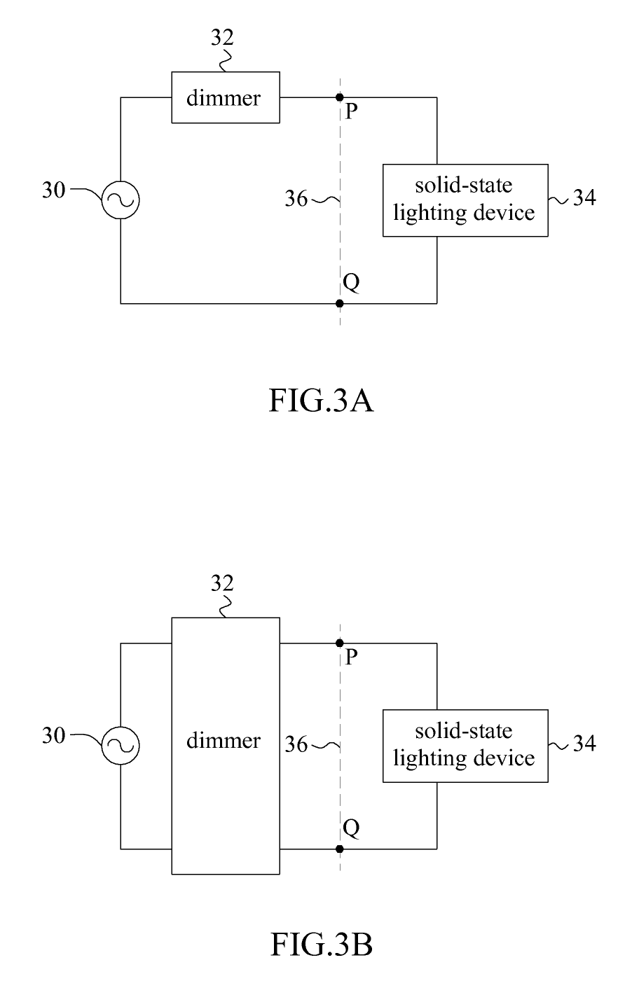

FIG. 3A shows a block diagram of a dimming system, which includes a dimmable solid-state lighting device of the present invention. In the embodiment, the dimming system includes an alternating-current power supply 30, a dimmer 32 and a solid-state lighting device 34. The dimmer 32 and the solid-state lighting device 34 are connected in series, and then the dimmer and the solid-state lighting device 34 are respectively connected to two ends of the alternating-current power supply 30. In FIG. 3A, the left side of a dotted line 36, which connects the nodes P and Q, may represent a lamp holder electrically connected to the alternating-current power supply 30, and a conventionally alternating-current dimmer 32 (as being the dimmer 10 shown in FIG. 1B) is configured above the lamp holder. The right side of the dotted line may represent a solid-state lighting (i.e. the solid-state lighting device 34), which may be made into a conventional shape of the incandescent light bulb, for being rotatingly mounted in the socket of the lamp holder. FIG. 3B shows a block diagram of another dimming system according to another embodiment of the present invention. In the embodiment, the dimming system also includes an alternating-current power supply 30, a dimmer 32 and a solid-state lighting device 34. The dimmer 32 and the solid-state lighting device 34 are connected in parallel, and then the dimmer 32 is connected to two ends of the alternating-current power supply 30.

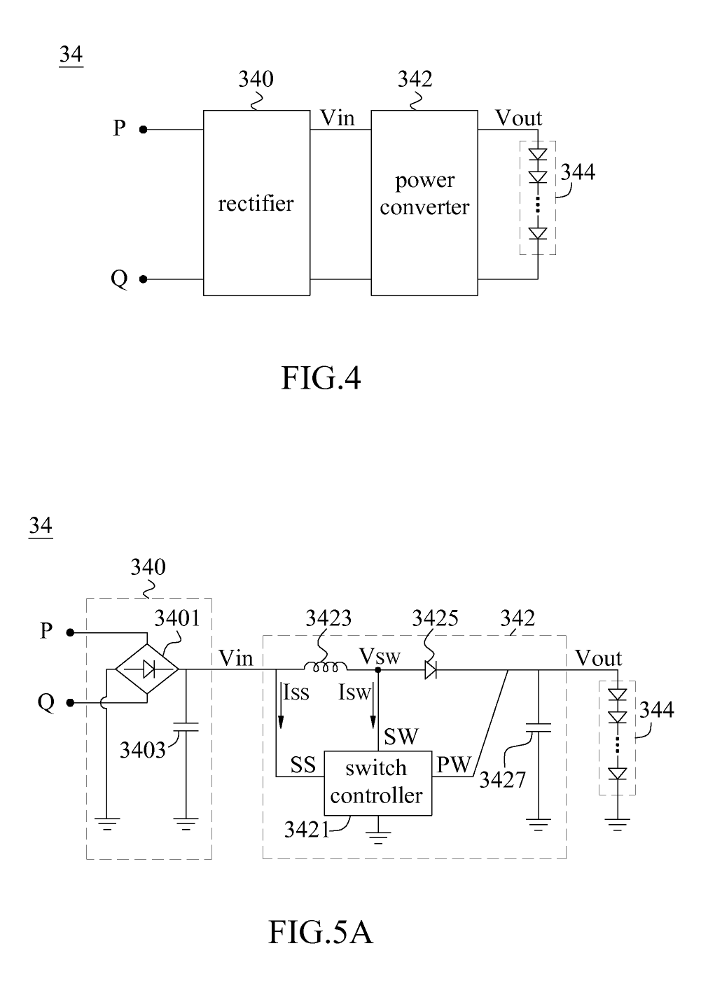

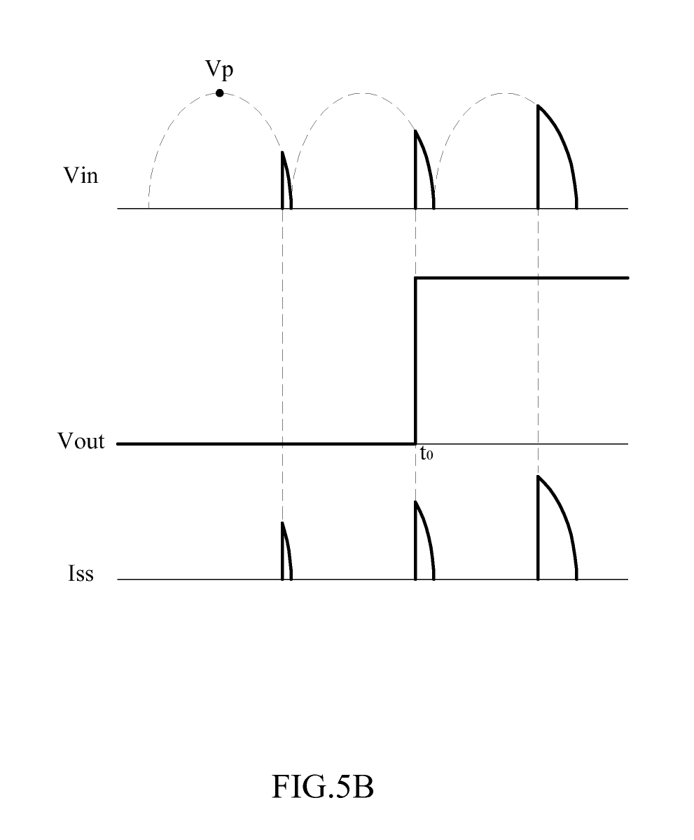

FIG. 4 shows a detailed block diagram of a dimmable solid-state lighting device 34 according to an embodiment of the present invention. In the embodiment, the solid-state lighting device 34 includes a rectifier 340, a non-isolated switching boost power converter 342 and at least one solid-state lighting element 344. The rectifier 340 receives an output of the dimmer 32, and then converts the output into a rectified voltage Vin. Subsequently, the non-isolated switching boost power converter (hereinafter abbreviated to “power converter”) 342 receives the rectified voltage Vin to generate an output voltage Vout, which is provided to the solid-state lighting element 344.

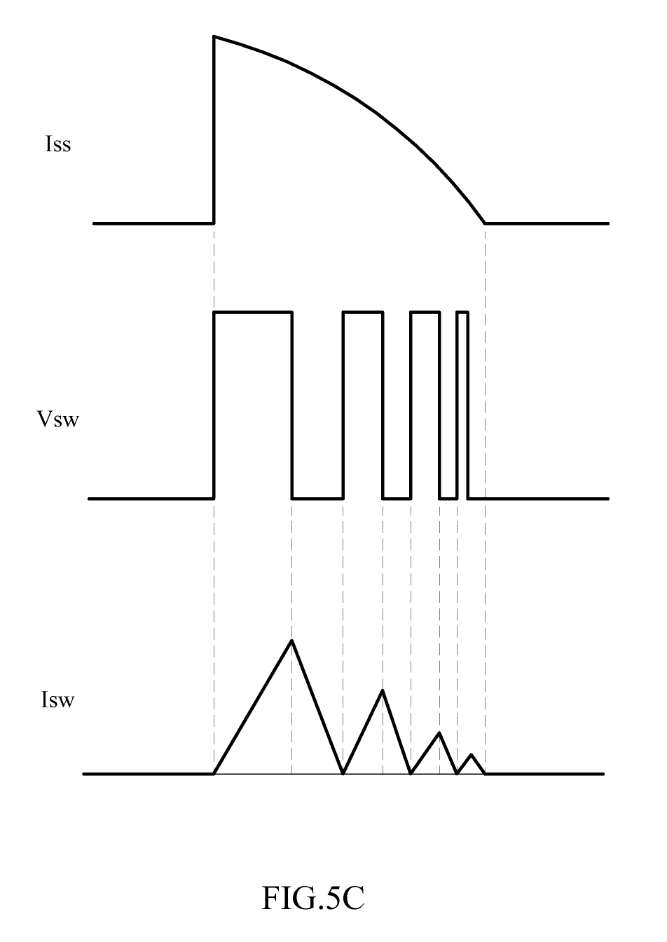

FIG. 5A shows a detailed circuit diagram of a solid-state lighting device 34 according to an embodiment of the present invention. In the embodiment, a rectifier 340 includes a bridge rectifier 3401, wherein a capacitor 3403 with a small capacitance may be connected between the output of the bridge rectifier 3401 and a ground to reduce or eliminate EMI, and the capacitor 3403 has nothing to do with the rectification and filtering. The solid-state lighting element 344 may be, but not limited to, a light emitting diode (LED), an organic light emitting diode (OLED) or a polymer light emitting diode (PLED). The power converter 342, in the embodiment, mainly includes a switch controller 3421, an inductor 3423, a diode 3425 and a load capacitor 3427. The switch controller 3421 has some nodes as below: a detecting terminal SS coupled to an input Vin, a control terminal SW and a power terminal PW coupled to an output Vout. The inductor 3423 is used as an energy storage element, wherein a first end of the inductor 3423 is connected to the input Vin of the power converter 342, and the second end of the inductor 3423 is connected to the control terminal SW of the switch controller 3421 and an end of the diode 3425. The diode 3425 is used as a single switch element, which is connected between a second end of the inductor 3423 and the output Vout. In the embodiment, an anode of the diode 3425 is connected to the second end of the inductor 342, and a cathode of the diode 3425 is connected to the output Vout of the power converter 342. The load capacitor 3427 is connected between the output Vout and a ground.

If the switch controller 3421 is in an on state, the control terminal SW is electrically conducted to the ground. In the on state, the rectified voltage generated from the rectifier 340 will charge inductor 3423 through the input Vin, and therefore the energy may be stored in the inductor 3423. If the switch controller 3421 is in an off state, the control terminal SW is electrically isolated from the ground. In the off state, the inductor 3423 will discharge the load capacitor 3427 and the solid-state lighting element 344 through the diode 3425, and therefore the energy may be transferred to the load capacitor 3427 and the solid-state lighting element 344.

FIG. 5B shows the related waveforms of an input rectified voltage Vin, an output voltage Vout and a detecting terminal current Iss. As shown in FIG. 5B, the rectified voltage Vin may be a full-wave rectified waveform, and the peak is Vp. If the rectified voltage Vin reaches the operating voltage of the switch controller 3421, as the triggering point at time to shown in FIG. 5B, the output voltage Vout will be outputted and be maintained in a state of being higher than the rectified voltage Vin. In accordance with the embodiment, the output voltage Vout of the power converter 342 may be greater than the peak Vp of the input rectified voltage Vin. Consequently, in the embodiment, the output voltage Vout is coupled to the power terminal PW of the switch controller 3421, so as to be provided as the operating voltage of the switch controller 3421. As a result, the abnormal operation, which is caused by the conventional power converter for the lack of the adequate operating voltage, will not take place.

The spirit of the present invention is the circuit design of the power converter 342 with the use of the detecting and switching function of the switch controller 3421 and the connection with other element, so that the power converter 342 may output an output voltage Vout, which is maintained higher than the peak Vp of the rectified voltage. That is to say, the switch controller may be a circuit chip which can be known by those skilled in the art that to have the function of detecting and switching. The switch controller includes, but not limited to, an oscillator or a power controller with a fixed frequency or a variable frequency waveform output.

FIG. 5C shows the partial enlarged views of the waveforms of the current Iss at the detecting terminal SS and the voltage Vsw at the control terminal SW of the switch controller 3421, after the power converter 342 begins to output voltage Vout. The switch controller 3421 detects the rectified voltage Vin or the current Iss by the detecting terminal SS, in order to determine the energy that the switch controller 3421 transfers to the solid-state lighting element 344. As shown in FIG. 5C, the pulse width modulation (PWM) is used in the embodiment to adjust the current Isw at the control terminal SW, which outputs the energy corresponding to the value of current Iss (Vin) at the detecting terminal, so as to have the effect of stabilizing dimming light output. It can be easily understood that, although the different switch controllers may generate the different control terminal voltages Vsw and the different output waveforms and frequencies of the current Isw, the control terminal current Isw will still output the energy corresponding to the value of the detecting terminal Iss (Vin).

According to the above mentioned configurations and functions, when the operating voltage of the switch controller 3421 is as low as possible, even though the output voltage waveform of the dimmer 32 is in a low output state (i.e., in a low voltage), the switch controller 3421 still can generate enough voltage output to drive the solid-state lighting element 344, such that the solid-state lighting element 344 may maintain in a dim light state. That is to say, the brightness of the solid-state lighting element 344 may correspond to the voltage adjustment range of the dimmer 32 without flickering.

The present invention is ideal for use in the power converter 342 based on the high voltage solid-state lighting element 344, the withstand voltage of the solid-state lighting element 344 may be the peak Vp of the rectified voltage. If the voltage (Vout) of the solid-state lighting element 344 is appropriately chosen to be relatively higher than a peak Vp of the rectified voltage, it may increase the efficiency of the switch controller 3421 and decrease the power consumption and the loading at the switch controller 3421 and the inductor 3423. Furthermore, as the input rectified voltage Vin of the power converter 342 in the present embodiment does not require an almost steady direct-current, therefore the rectifier 340 no longer needs a conventional capacitor with a large capacitance. Instead, the present embodiment only requires a capacitor 3403 with a small capacitance, which is used to reduce or eliminate EMI and has nothing to do with the rectification and filtering, or the capacitor 3403 may be omitted. The overall framework of the present invention is close to a resistive circuit, and the voltage and the current are in the same phase, so that a higher power factor may be obtained.

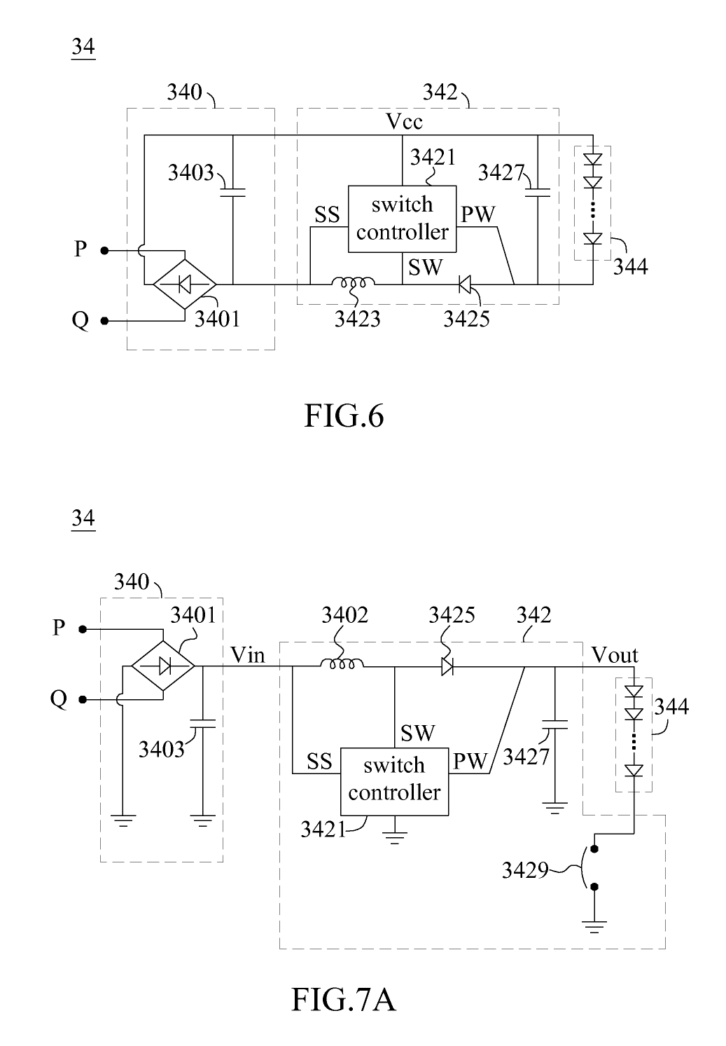

FIG. 6 shows a detailed circuit diagram of the solid-state lighting device 34 according to another embodiment of the present invention. The present embodiment as shown in FIG. 6 is similar to the above embodiment as shown in FIG. 5A, and the difference between the embodiments is that the circuit in FIG. 5A utilizes the ground to act as the common node, and the circuit in FIG. 6 utilizes the power supply Vcc to act as the common node, therefore resulting in a negative output. In the embodiment, a cathode of the diode 3425 is connected to a second end of the inductor 3423, and an anode of the diode 3425 is connected to the output Vout of the power converter 342.

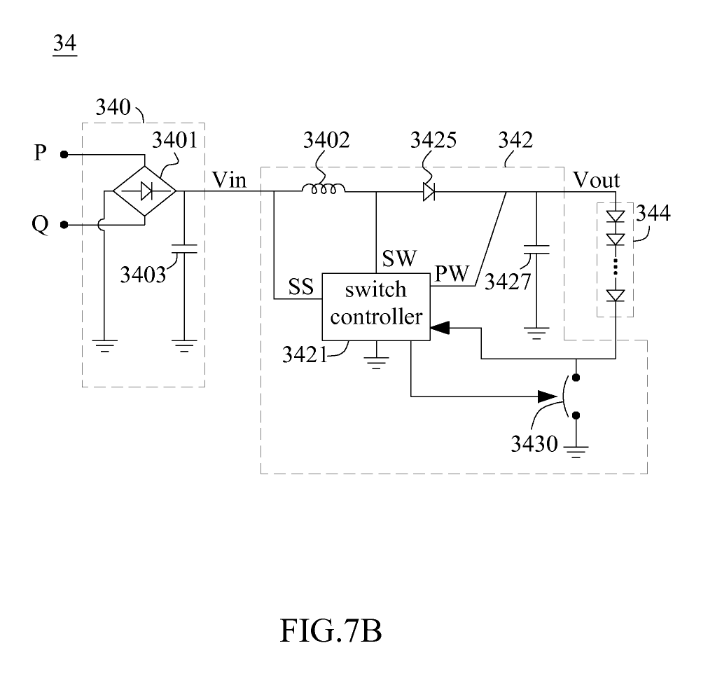

FIG. 7A shows a detailed circuit diagram of the solid-state lighting device 34 according to another embodiment of the present invention. The present embodiment as shown in FIG. 7A is similar to the above embodiment as shown in FIG. 5A, and the difference is that there is a circuit protection device 3429 inserted between the solid-state lighting element 344 and the ground in the present embodiment. If the alternating-current power supply 30 generates an abnormally high voltage (for example, impulses), the current of the solid-state lighting element 344 will be limited to a highest rated value in accordance with W=V×I (V representing a voltage of the solid-state lighting element 344, I representing the rated value, and W representing a power consumption of the solid-state lighting element 344), and consequently the solid-state lighting element 344 may be prevented from the burn-out due to the high power.

FIG. 7B shows a detailed circuit diagram of the solid-state lighting device 34 according to another embodiment of the present invention. The present embodiment as shown in FIG. 7B is similar to the embodiment as shown in FIG. 7A, and the difference is that, in the present embodiment, there is a variable circuit protection device 3430 additionally inserted between the solid-state lighting element 344 and the ground. The variable circuit protection device 3430 not only can have the function of the circuit protection device 3429 mentioned in the above embodiment, but also can provide a feedback signal to the switch controller 3421 for adjusting the output as being operated at an extremely high voltage, in order to avoid the damage of the variable circuit protection device 3430 which may further influence the lifetime of the solid-state lighting element 344. In a preferred embodiment, after the switch controller 3421 receives the feedback signal of the variable circuit protection device 3430, the switch controller 3421 may adjust the limiting for the loading of the variable circuit protection device 3430.

It will be appreciated by those skilled in the art that the type of the overvoltage limiting protection is not limited to a particular type. For example, the real-time overvoltage limiting protection or the average overvoltage limiting protection all can be applied in the present invention.

The power converter in the present invention is mainly for the high voltage resulting from the design of a series connection of the solid-state lighting element 344 (Vp≦Vout=VLED, VLED representing a voltage of a light emitting diode). When the solid-state lighting device 34 utilizes the design with the variable circuit protection device 3430 mentioned above, the solid-state lighting element 344 will not be limited to the high voltage, and may be utilized in the low voltage (i.e., VLED<VP).

Although specific embodiments have been illustrated and described, it will be appreciated by those skilled in the art that various modifications may be made without departing from the scope of the present invention, which is intended to be limited solely by the appended claims.

What is claimed is:

1. A non-isolated switching boost power converter, comprising:
a switch controller;
an energy storage element, wherein a first end of the energy storage element is connected to an input of the power converter, and a second end of the energy storage element is connected to a control terminal of the switch controller;
a single switch element, connected between the second end of the energy storage element and an output of the power converter; and
a load capacitor, connected between the output and a common node;
wherein if the switch controller is in an on state, the control terminal of the switch controller is electrically conducted to the common node, and rectified voltage charges the energy storage element through the input; and if the switch controller is in an off state, the control terminal of the switch controller is electrically isolated from the common node, and the energy storage element discharges a solid-state lighting element through the single switch element.

2. The power converter of claim 1, wherein the energy storage element comprises an inductor.

3. The power converter of claim 1, wherein the single switch element comprises a diode.

4. The power converter of claim 1, wherein the common node is a ground or a power supply.

5. The power converter of claim 1, wherein the switch controller comprises an oscillator or a power controller with a fixed frequency or a variable frequency waveform output.

6. The power converter of claim 1, wherein the switch controller further comprises a power terminal coupled to the output, and an output voltage is utilized to act as an operating voltage of the switch controller.

7. A method of providing a direct-current voltage to a dimmable solid-state lighting device, comprising using the power converter of claim 1 to output a direct-current voltage.

8. A dimmable solid-state lighting device, comprising:
a rectifier, receiving an output of a dimmer and converting the output into a rectified voltage per claim 1;
at least one solid-state lighting element per claim 1; and
a power converter per claim 1, receiving the rectified voltage to output a direct-current voltage which is provided to the solid-state lighting element.

9. The solid-state lighting device of claim 8, further comprising a capacitor, connected between an output of the rectifier and a common node.

10. The solid-state lighting device of claim 8, further comprising a circuit protection device, configured between the solid-state lighting element and a common node.

11. The solid-state lighting device of claim 10, wherein the circuit protection device is a variable circuit protection device.

12. The solid-state lighting device of claim 10, wherein the said circuit protection device is a real-time circuit protection device or an average circuit protection device.

13. The solid-state lighting device of claim 9, wherein the common node is a ground or a power supply.

14. The solid-state lighting device of claim 10, wherein the common node is a ground or a power supply.

15. The solid-state lighting device of claim 8, wherein the solid-state lighting element is a LED, an OLED or a PLED.
